(19) United States
(12) Patent Application Publication
(10) Pub. No.: US 2024/0143692 A1
(43) Pub. Date: May 2, 2024

(54) Method of Intelligent Matrix Solving Approach Enhanced with Integrated Realtime Machine Learning Training and Inference

(71) Applicant: Jun Zhou, Austin, TX (US)

(72) Inventors: Jun Zhou, Austin, TX (US); Xiaoyun Liu, College Station, TX (US)

(73) Assignee: Jun Zhou, Austin, TX (US)

(21) Appl. No.: 17/976,320

(22) Filed: Oct. 28, 2022

(51) Int. Cl. G06F 17/16; G06K 9/62; G06N 20/00

(52) U.S. Cl. CPC G06F 17/16; G06K 9/6228; G06K 9/6262; G06N 20/00

(57) ABSTRACT

A method trains and generates a matrix solving approach library package for optimizing a matrix solving application. A computer system with implemented the method may 1) receive requests to train a matrix solving Machine Learning (ML) model; 2) design a model structure of the ML Model accordingly; 3) select a set of matrices solving sampling data for training the defined matrix solving ML model; 4) use the selected matrix solving data and constructed IMSA Structure as inputs to train the matrix solving ML model; 5) generates a new matrix solving ML model with optimized IMSA parameters as ML model outputs; optimize the weights for each ML model node according to the provided training data sets; 6) verify the trained matrix solving approach library package with untrained data sets (matrix solving problems). The trained matrix solving approach library package may optimize matric solving application for solving matrix with result.

### BACKGROUND

The present disclosure relates generally to the field of machine learning technology, and more particularly to matrix solving model training and inference for solving complex problems.

The field of machine learning technology is one of important parts in artificial intelligent computing for understanding and building modules, programs, hardware methods that can learn and solving problems that leverage data to improve performance on some set of tasks.

A matrix is a rectangular array or table of numbers, symbols, or expressions, arranged in rows and columns, which is used to represent a mathematical object or a property of such an object. Matrices are widely used for specifying and representing geometric transformations (for example rotations) and coordinate changes. In numerical analysis, many computational problems are solved by reducing them to a matrix computation, and this often involves computing with matrices of huge dimension. Matrices are used in most areas of mathematics and most scientific fields, either directly, or through their use in geometry and numerical analysis.

Matrix solving is the dominant runtime component for ordinary differential equations (ODE) and partial differential equations (PDE) scientific/engineering matrix solving approach application especially in Electronic Design Automation (EDA), includes circuit simulation, P&R (place-and-route) optimization, power analysis/optimization, and other engineering fields.

In modern EDA matrix solving approach application, the matrix solving is base operation which heavily determines the algorithm performance and result quality. For such matrix solving (direct method or iteration method), the following list cover the most parameters/strategies mostly used to control matrix solving behavior: matrix partitioning for parallelization, Pivoting/re-ordering, preconditioner, ordinary differential equations (ODEs) time step aware (or optimization target function aware) convergence tolerance control Degeneracy detection and avoidance.

Currently, all parameters as listed in above are manually coded into EDA software/algorithms and requires deep knowledge and extensive regression/debugging to be optimized. A lot of domain knowledge and experience are implicitly embedded and hard coded in the EDA software algorithm for a specific circuit style/technology-node after extensive testing, debugging, and regression. However, the hard-coded/embedded knowledge might not always meet new requirements for a new type of circuitry, new operating point, or new process node. It requires manual re-tuning periodically for new type of circuitry, new operating point, or new process node.

### SUMMARY

Embodiments of the present disclosure include a computer implemented method, apparatus, system, and computer program product (software and hardware) trains and generates a matrix solving approach library package for optimizing a matrix solving application. A computer system receives requests to train and generate a matrix solving Machine Learning (ML) model associated the type of requested problems and domain. The computer system designs a model structure of the Machine Learning (ML) Model for the received type of requested problems and domain. The computer system selects a set of matrices solving sampling data for training the defined matrix solving Machine Learning (ML) model. The computer system using the selected matrix solving data and constructed IMSA Structure as inputs to train the matrix solving Machine Learning (ML) model. The computer system generates a new matrix solving Machine leaning model with optimized IMSA parameters as Machine leaning model output: Matrix partitioning; Pivoting; Preconditioner; convergence tolerance; degeneracy avoidance. The computer system optimizes the weights for each Machine leaning model node according to the provided training data sets for the specific matrix solving application domain. The computer system verifies the generated and trained matrix solving approach library package with untrained data sets (matrix solving problems). A installed trained matrix solving approach library package as part of a computer implemented method, apparatus, system, and computer program product (software and hardware) optimizes matric solving application for solving matrix with result.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an exemplary embodiment of Intelligent Matrix Solving Approach, in accordance with embodiments of the present disclosure.

FIG. 2 illustrates a high-level structure of Intelligent Matrix Solving Approach, in accordance with embodiments of the present disclosure.

FIG. 3A illustrates a detailed training structure of Intelligent Matrix Solving Approach, in accordance with embodiments of the present disclosure.

FIG. 3B illustrates a detailed library structure of Intelligent Matrix Solving Approach system, in accordance with embodiments of the present disclosure.

FIG. 4 illustrates an exemplary embodiment flowchart of training and learning structure for Intelligent Matrix Solving Approach, in accordance with embodiments of the present disclosure.

FIG. 5 illustrates an exemplary embodiment flowchart of library structure for Intelligent Matrix Solving Approach, in accordance with embodiments of the present disclosure.

FIG. 6 illustrates an exemplary embodiment operation steps of training and learning structure for Intelligent Matrix Solving Approach, in accordance with embodiments of the present disclosure.

FIG. 7 illustrates an exemplary embodiment operation steps of library structure for Intelligent Matrix Solving Approach, in accordance with embodiments of the present disclosure.

FIG. 8A illustrates a cloud computing environment, in accordance with embodiments of the present disclosure.

FIG. 8B illustrates abstraction model layers, in accordance with embodiments of the present disclosure.

FIG. 9 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of machine learning technology, and more particularly to matrix solving optimization in application level. Matrix solving is fundamental runtime component for ordinary differential equations (ODE) and partial differential equations (PDE) scientific/engineering matrix solving approach application especially in Electronic Design Automation (EDA), includes circuit simulation, P&R (place-and-route) optimization, power analysis/optimization, and other engineering fields.

In EDA matrix solving approach application, the matrix solving is base operation which heavily determines the algorithm performance and result quality. For such matrix solving (direct method or iteration method), the following list cover the most parameters/strategies mostly used to control matrix solving behavior: matrix partitioning for parallelization, Pivoting/re-ordering, preconditioner, ordinary differential equations (ODEs) time step aware (or optimization target function aware) convergence tolerance control Degeneracy detection and avoidance.

If all parameters as listed in above are manually coded into EDA software/algorithms, then it requires deep knowledge and extensive regression/debugging to be optimized. Many such domain knowledge/experience are implicitly embedded and hard coded in the EDA software algorithm for a specific circuit style/technology-node after extensive testing, debugging, and regression. However, the hard-coded/embedded knowledge might not always meet new requirements for a new type of circuitry, new operating point, or new process node. It requires manual re-tuning periodically for new type of circuitry, new operating point, or new process node.

Despite its effectiveness, matrix solving can considerably impact and effect how dependent application productivities. For example, EDA application such as circuit simulation, could take days instead of hours to finish if a bad matrix partition is chosen.

In embodiments discussed herein, provided are solutions in the form of a method, system, and computer program product for supporting Intelligent Matrix Solving Approach (IMSA) Enhanced with Integrated Realtime Machine Learning Training and Inference. In embodiments, such solutions may be implemented in one or more software applications located on one more computer system and which the person (e.g., admin and or user) has opted-in to add matrix sample data.

In some embodiments, a computer program method may receive a request to train and generate a matrix solving Machine Learning (ML) model associated the type of requested problems and domain. In some embodiments, the computer program module may construct and design a model structure of the Machine leaning model (e.g. convolutional neural network, CNN) for the received type of requested problems and domain.

The computer program method may select a set of matrix solving sampling data for training the defined matrix solving Machine learning model. The computer program method may use the selected matrix solving data and constructed IMSA Structure as inputs to train the matrix solving Machine learning model. The trained matrix solving Machine learning models for the targeting IMSA Application (EDA or other scientific matrix solving approach applications) can be designed as Convolution Neural Networks (CNN), Recurrent Neural Networks (RNN) models, or other Machine learning models.

In some embodiments, the computer program method may generate a new matrix solving Machine leaning model with optimized matrix solving approach parameters as Machine leaning model output: Matrix partitioning; Pivoting; Preconditioner; convergence tolerance; degeneracy avoidance. The parameters (and beyond) can be explicitly presented in the Machine leaning model that is separated from any existing software/algorithms. In some embodiments, the computer program method may train and optimize the weights for each Machine leaning model node according to the provided training data sets (e.g. matrix solving problem sets) for the specific matrix solving approach application domain.

In some embodiments, the computer program method may verify generated IMSA model with untrained data sets (matrix solving problems).

For example, we can use existing QA testcase with golden (best-so-far) solution (not in our training set) to validate our trained matrix solving Machine learning model. If the matrix solving parameters recommended by the Machine learning model, generates better solution, or similar solutions with faster runtime, it means that the Machine leaning model is superior to the previous/existing hardcoded domain knowledge in the software.

In some embodiments, a computer program method may install IMSA library package with an untrained (or pre-trained for targeting IMSA Application) IMSA model. The computer program method may receives a matrix solving request includes the untrained IMSA model from IMSA Client.

In some embodiments, the computer program method may solve the received matrix with IMSA Model. The computer program method may also retrain and purify request IMSA Model incrementally under supervising with the latest hardware (e.g. cloud+GPU) during real IMSA Application.

In some embodiments, the computer program method may update the purified IMSA Model Continuing to solve the requested matric until to searched acceptable results. IMSA model inference result can be selectively applied to the matrix solving during real IMSA Application under supervision. The computer program method may return solved matrix with results.

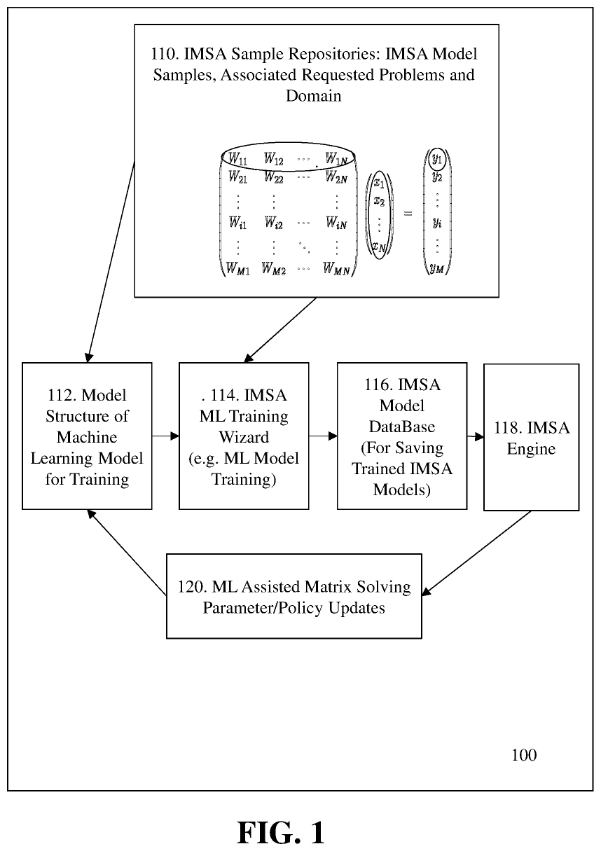

Referring now to FIG. 1, a block diagram of Intelligent Matrix Solving Approach system 100, is depicted in accordance with embodiments of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, Intelligent Matrix Solving Approach system 100 can include IMSA Sample Repositories 110, Model Structure of Machine Learning Model 112, IMSA ML Training Wizard 114, IMSA Model DataBase 116, IMSA Engine 118, ML assisted Matrix Solving Parameter/Policy Updates 120, which are connected. In embodiments, IMSA Sample Repositories 110 may contain all IMSA Model Samples, Associated Requested Problems and Domain. Model Structure of Machine Learning Model 112 can be created and designed during the training. IMSA ML Training Wizard 114 is core leaning module conducting model training process. IMSA Model DataBase 116 is a database for saving the trained matrix solving. IMSA Engine 118 may receive a matric solving request and use the trained matric solving mode to solve the requested matrix and return associated results. ML Assisted Matrix Solving Parameter/Policy Updates 120 are the calculated matrix and associated results which may be used as new training samples.

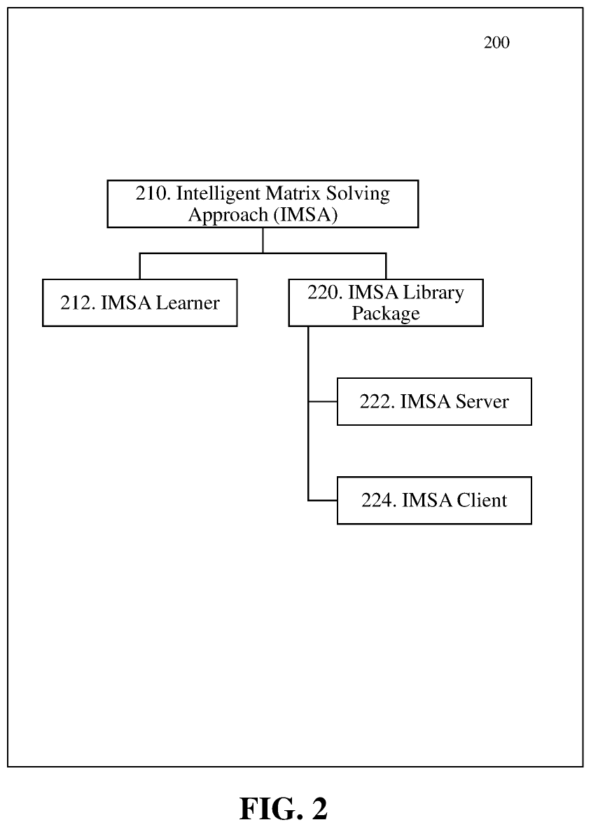

Referring now to FIG. 2, a high-level structure of Intelligent Matrix Solving Approach illustrating an example method 200 for training and generating an optimizing matric solving model in accordance with embodiments of the present disclosure. In some embodiments, the method 200 includes Intelligent Matrix Solving Approach (IMSA) 210 connected with two major sub systems: IMSA Learner 212 and IMSA Library Package 220. The IMSA Library Package 220 includes at least one optimized matrix solving model generated by IMSA Learner 212. The IMSA Library Package 220 may be shipped and installed in IMSA Server 222 as a matrix solving library to support certain applications, which need matrix solving during run time, in IMSA Client 224.

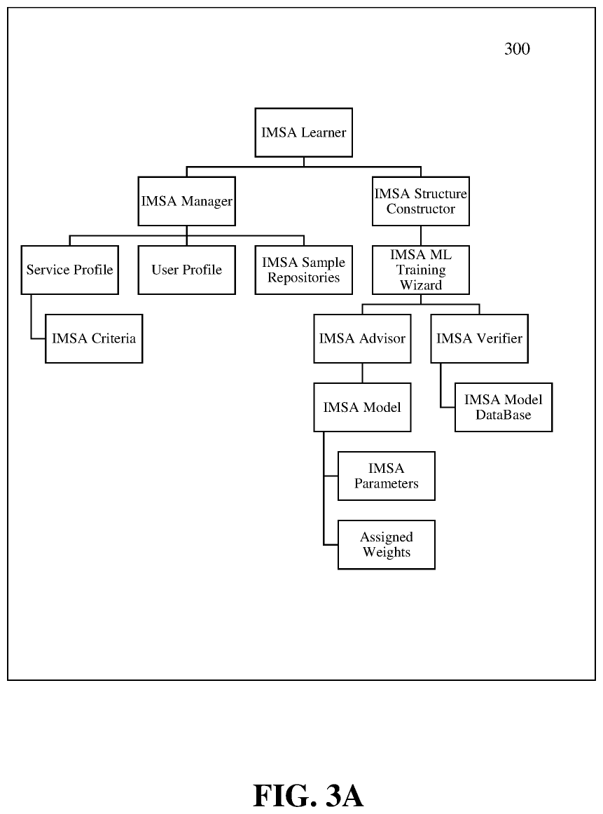

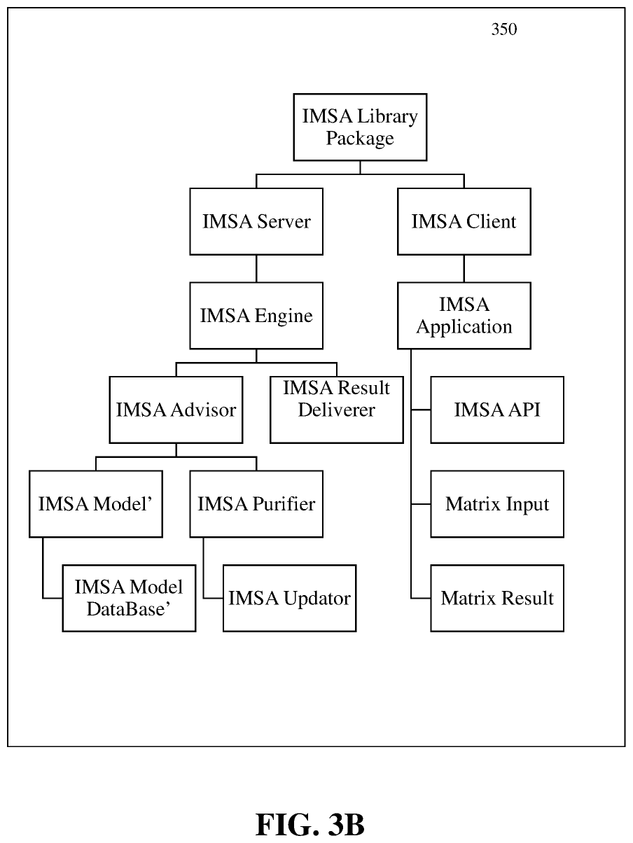

Referring now to FIG. 3A, a more detailed hierarchical structure of IMSA Learner illustrating an example method 300 for training and generating an optimizing matrix solving model, in accordance with embodiments of the present disclosure. In some embodiments, the IMSA Learner 300 may include more required components for generating, training, package, deliver a matrix solving model for solving certain problems.

Referring now to FIG. 3B, more detailed hierarchical structure of IMSA Library Package illustrating an example method 350 for using a installed optimized matrix solving model, in accordance with embodiments of the present disclosure. In some embodiments, the IMSA Library Package Learner may be configured as server and client style (not limited to) for support more matrix solving applications in client side.

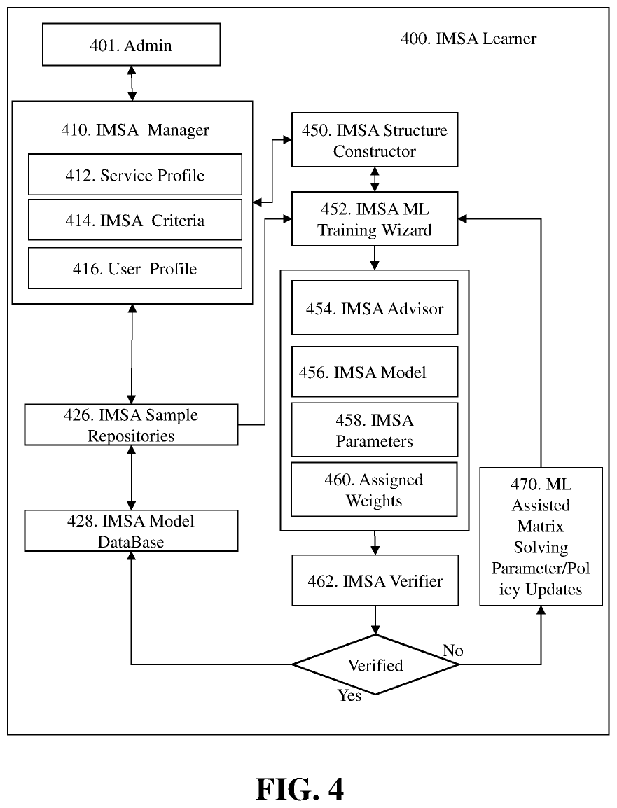

Referring now to FIG. 4, a flowchart illustrating an example method IMSA Leaner 400 for training matrix solving model in accordance with embodiments of the present disclosure. IMSA Learner. Admin 402 may use IMSA Manager 410 to configure and modify IMSA settings and save them into Service Profile 412. The settings may include IMSA Criteria 414 (ratio of samples for training and verification, thresholds of verifying trained models for different problems and domains, etc.) focused problems, or/and application types need to solve through matrix computing. Admin 402 may also setup User Profile(s) 416 for customizing matrix solving model training according to different requests for different needs. IMSA Sample Repositories 426 may contain matrix samples and associated parameters. Admin 402 may add samples manually and IMSA Verifier 462 may also add new verified matrix solving model associated problems and domains into IMSA Sample Repositories 426.

In some embodiments, IMSA Structure Constructor 450 may create and design structures for given problems and domains for those inputted matrix solving samples obtained from IMSA Sample Repositories 426, and then pass the designed structure to IMSA ML Training Wizard 452 for training a matrix solving model. IMSA ML Training Wizard 452 may work with IMSA Advisor 454 to train IMSA Model 456, adjust IMSA Parameters 458, adopt Assigned Weights 460, and then send the trained IMSA Model 456 to IMSA Verifier 462. IMSA Verifier 462 may check received the new trained IMSA Model 456 with IMSA Parameters 458 and Assigned Weights 460 with IMSA Criteria 414. If the new trained IMSA Model 456 with IMSA Parameters 458 can pass the IMSA Criteria 414, then IMSA Verifier 462 may save them into IMSA Model Dabase. If the new trained IMSA Model 456 with IMSA Parameters 458 can not pass the IMSA Criteria 414, then IMSA Verifier 462 may send them as ML Assisted Matrix Solving Parameter/Policy Updates 470 to into IMSA ML Training Wizard for further optimization, repeatedly.

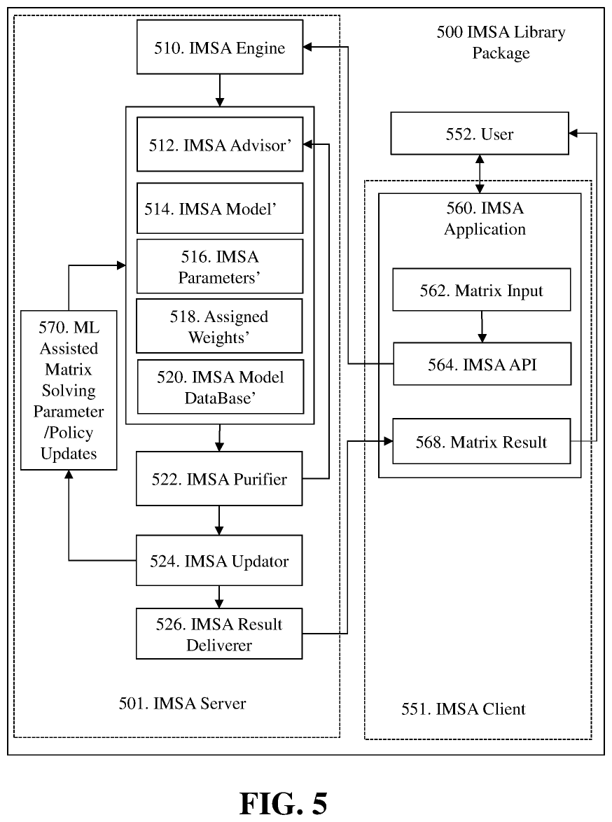

Referring now to FIG. 5, a flowchart illustrating an example method IMSA Library Package 500 for using trained matrix solving model in accordance with embodiments of the present disclosure. User 552 may purchase, or license trained IMSA Library Package, and install and configure it as server and client style (not limited to). IMSA Application 560 may send a matrix solving request, Matrix Input 564, to IMSA Server 501, through a connection between IMSA API 564 and IMSA Engine 510.

In some embodiments, IMSA Engine 510 may send new Matrix requested by ISMA Application 560 to IMSA Advisor′ 510 for solving it. Under IMSA Advisor′ 510 monitoring, the requested matrix may be solved by trained IMSA Model′ 514 with optimized IMSA Parameters' 516, Assigned Weights' 518 saved in IMSA Model Database's 520.

In some embodiments, IMSA Advisor′ 510 may interrupt the solving process if solving time and computer resource beyond a threshold and let IMSA Purifier 522 to adjust IMSA Parameters' 516 and Assigned Weights' 518 again, and then send the requested matrix with the adjusted IMSA Parameters' 516 and Assigned Weights' 518 to IMSA Model's 514 for resolving them. If IMSA Advisor′ 510 gets a solved the requested matrix and IMSA Purifier 522 also satisfies the solved matrix, then IMSA Updater may update the solved matrix with associated parameters as ML Assisted Matrix Solving Parameter/Policy Updates 570 to IMSA Model DataBase′ 520. And IMS Result Deliverer 526 can send the solve Matrix Result 568 back to IMSA Application 560 and User 552 in IMSA Client 551.

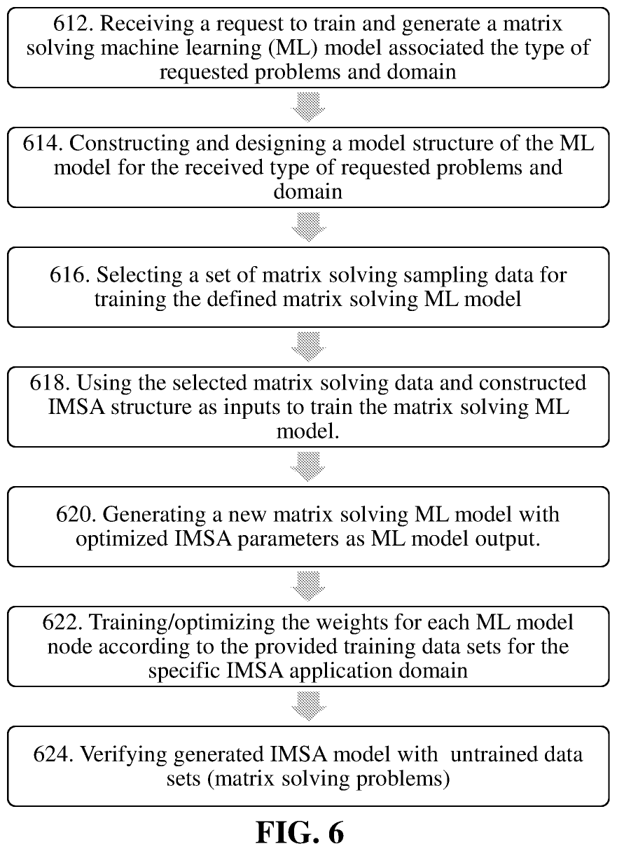

Referring now to FIG. 6, a set of operation steps of training and learning structure illustrating an example operation for optimizing matrix solving procedure, in accordance with embodiments of the present disclosure. In some embodiments, the training operation begins at operation step 612 where a computing method receives tasks with training samples to train and generate a matrix solving machine learning model associated the type of requested problems and domain. The tasks may include specific problems and constrains for solving certain type of applications. In step 614, the computing method may construct and design a model structure of the Machine leaning model for the received type of requested problems and domain. In step 616, the computing method may select a set of matrix solving sampling data for training the defined matrix solving Machine learning model. In step 618, the computing method may use the selected matrix solving data and constructed IMSA structure as inputs to train the matrix solving Machine learning model. In step 620, the computing method may generate a new matrix solving Machine leaning model with optimized IMSA parameters as Machine leaning model output. In step 622, the computing method may train/optimize the weights for each Machine leaning model node according to the provided training data sets for the specific IMSA application domain. In step 624, the computing method may verify generated IMSA model with untrained data sets (matrix solving problems).

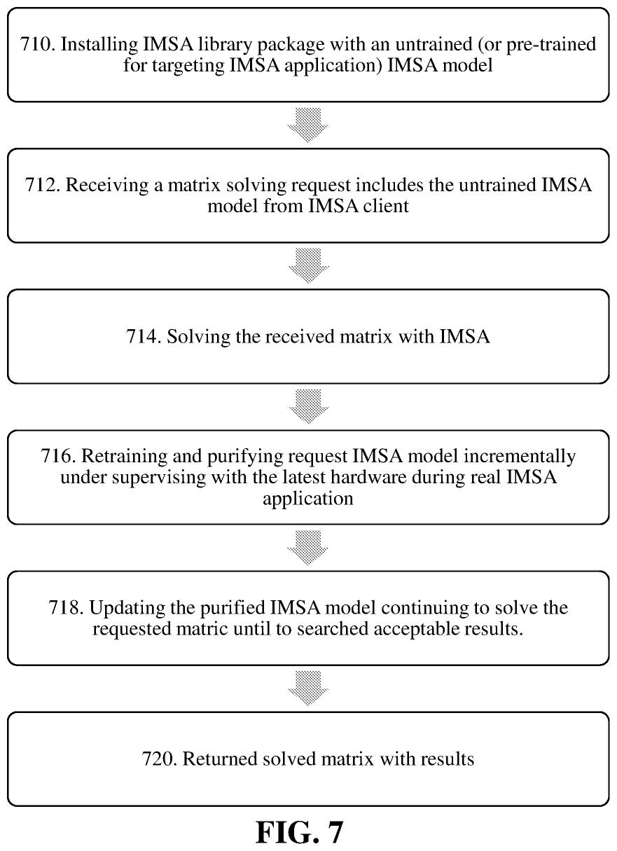

Referring now to FIG. 7, a set of operation steps of library package structure illustrating an example operation for optimizing matrix solving procedure, in accordance with embodiments of the present disclosure. In some embodiments, the new matrix solving operation begins at operation step 710 where a computing method install and setup the trained matrix solving library package on server and client style (not limited to) for solving certain matrix in a given application, type of problems, and domain. In step 710, IMSA library package with an untrained (or pre-trained for targeting IMSA application) IMSA model can be installed in a server. In step 712, the computing method receives a matrix solving request includes the untrained IMSA model from IMSA client. In step 714, the computing method solves the received matrix with IMSA. In step 716, the computing method retrains and purifies the requested IMSA model incrementally under supervising with the latest hardware during real IMSA application. In step 718, the computing method updates the purified IMSA model continuing to solve the requested matric until to searched acceptable results. In step 720, the computing method returns solved matrix with results to client.

As discussed in more detail herein, it is contemplated that some or all of the operations of the methods in all figures may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

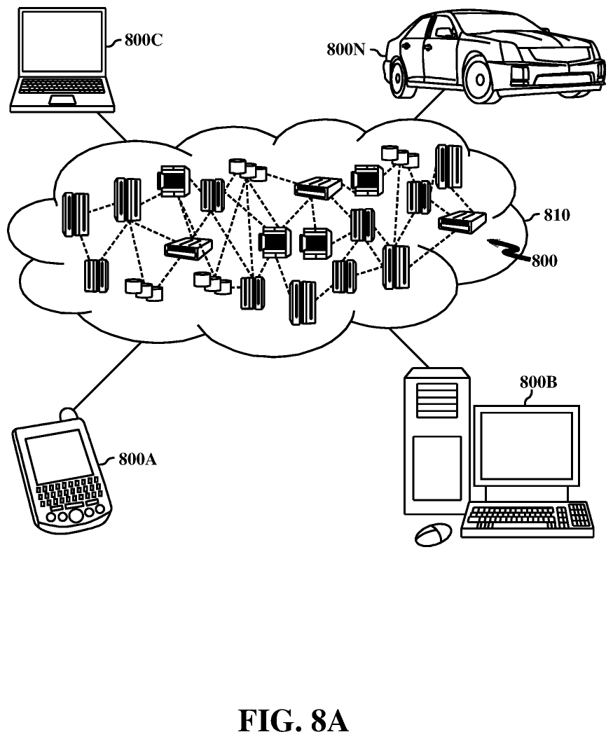

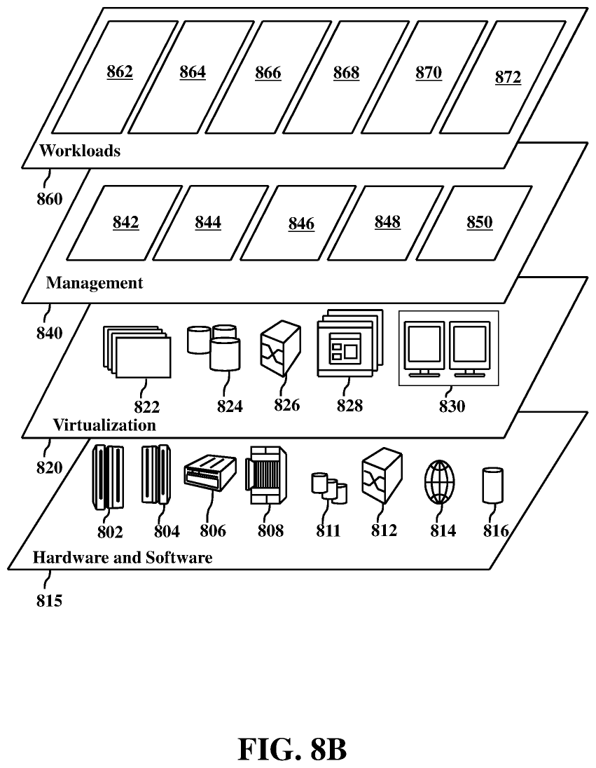

Referring now to FIG. 8A, illustrative cloud computing environment 810 is depicted. As shown, cloud computing environment 810 includes one or more cloud computing nodes 800 with which local computing devices used by cloud consumers, such as, for example, personal digital assistant (PDA) or cellular telephone 800A, desktop computer 800B, laptop computer 800C, and/or automobile computer system 800N may communicate. Nodes 800 may communicate with one another. They may be grouped (not shown) physically or virtually, in one or more networks, such as Private, Community, Public, or Hybrid clouds as described hereinabove, or a combination thereof. This allows cloud computing environment 810 to offer infrastructure, platforms and/or software as services for which a cloud consumer does not need to maintain resources on a local computing device. It is understood that the types of computing devices 800A-N shown in FIG. 8A are intended to be illustrative only and that computing nodes 800 and cloud computing 800 and cloud computing environment 810 can communicate with any type of computerized device over any type of network and/or network addressable connection (e.g., using a web browser).

Referring now to FIG. 8B, a set of functional abstraction layers provided by cloud computing environment 810 (FIG. 8A) is shown. It should be understood in advance that the components, layers, and functions shown in FIG. 8B are intended to be illustrative only and embodiments of the disclosure are not limited thereto. As depicted below, the following layers and corresponding functions are provided.

Hardware and software layer 815 include hardware and software components. Examples of hardware components include: mainframes 802; RISC (Reduced Instruction Set Computer) architecture based servers 804; servers 806; blade servers 808; storage devices 811; and networks and networking components 812. In some embodiments, software components include network application server software 814 and database software 816.

Virtualization layer 820 provides an abstraction layer from which the following examples of virtual entities may be provided: virtual servers 822; virtual storage 824; virtual networks 826, including virtual private networks; virtual applications and operating systems 828; and virtual clients 830.

In one example, management layer 890 may provide the functions described below. Resource provisioning 842 provides dynamic procurement of computing resources and other resources that are utilized to perform tasks within the cloud computing environment. Metering and Pricing 844 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 846 provides access to the cloud computing environment for consumers and system administrators. Service level management 848 provides cloud computing resource allocation and management such that required service levels are met. Service Level Agreement (SLA) planning and fulfillment 850 provide pre-arrangement for, and procurement of, cloud computing resources for which a future requirement is anticipated in accordance with an SLA.

Workloads layer 860 provides examples of functionality for which the cloud computing environment may be utilized. Examples of workloads and functions which may be provided from this layer include: mapping and navigation 862; software development and lifecycle management 864; virtual classroom education delivery 866; data analytics processing 868; transaction processing 870; and Intelligent Matrix Solving Approach 872.

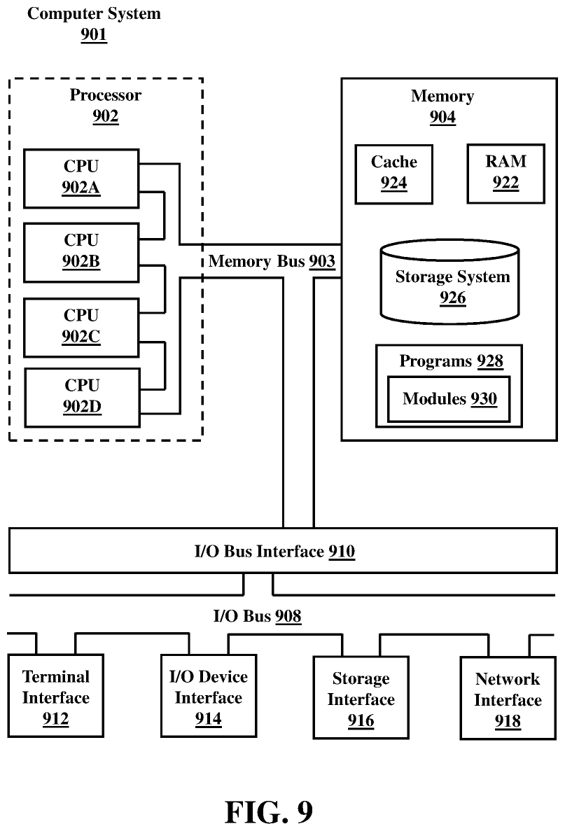

FIG. 9, illustrated is a high-level block diagram of an example computer system 901 that may be used in implementing one or more of the methods, tools, and modules, and any related functions, described herein (e.g., using one or more processor circuits or computer processors of the computer), in accordance with embodiments of the present invention. In some embodiments, the major components of the computer system 901 may comprise one or more Processor 902, a memory subsystem 904, a terminal interface 912, a storage interface 916, an I/O (Input/Output) device interface 914, and a network interface 918, all of which may be communicatively coupled, directly or indirectly, for inter-component communication via a memory bus 903, an I/O bus 908, and an I/O bus interface unit 910.

The computer system 901 may contain one or more general-purpose programmable central processing units (CPUs) 902A, 902B, 902C, and 902D, herein generically referred to as the CPU 902. In some embodiments, the computer system 901 may contain multiple processors typical of a relatively large system; however, in other embodiments the computer system 901 may alternatively be a single CPU system. Each CPU 902 may execute instructions stored in the memory subsystem 904 and may include one or more levels of on-board cache.

System memory 904 may include computer system readable media in the form of volatile memory, such as random access memory (RAM) 922 or cache memory 924. Computer system 901 may further include other removable/non-removable, volatile/non-volatile computer system storage media. By way of example only, storage system 926 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 904 can include flash memory, e.g., a flash memory stick drive or a flash drive. Memory devices can be connected to memory bus 903 by one or more data media interfaces. The memory 904 may include at least one program product having a set (e.g., at least one) of program modules that are configured to carry out the functions of various embodiments.

One or more programs/utilities 928, each having at least one set of program modules 930 may be stored in memory 904. The programs/utilities 928 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 928 and/or program modules 930 generally perform the functions or methodologies of various embodiments.

Although the memory bus 903 is shown in FIG. 9 as a single bus structure providing a direct communication path among the CPUs 902, the memory subsystem 904, and the I/O bus interface 910, the memory bus 903 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 910 and the I/O bus 908 are shown as single respective units, the computer system 901 may, in some embodiments, contain multiple I/O bus interface units 910, multiple I/O buses 908, or both. Further, while multiple I/O interface units are shown, which separate the I/O bus 908 from various communications paths running to the various I/O devices, in other embodiments some or all of the I/O devices may be connected directly to one or more system I/O buses.

In some embodiments, the computer system 901 may be a multi-user mainframe computer system, a single-user system, or a server computer or similar device that has little or no direct user interface, but receives requests from other computer systems (clients). Further, in some embodiments, the computer system 901 may be implemented as a desktop computer, portable computer, laptop or notebook computer, tablet computer, pocket computer, telephone, smartphone, network switches or routers, or any other appropriate type of electronic device.

It is noted that FIG. 9 is intended to depict the representative major components of an exemplary computer system 901. In some embodiments, however, individual components may have greater or lesser complexity than as represented in FIG. 9, components other than or in addition to those shown in FIG. 9 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer implement method for optimizing a matrix solving approach enhanced with integrated real time machine learning training and inference, the method comprising:
installing, by a first computer system, a trained matrix solving approach library package with an untrained or pre-trained for targeting matrix solving approach application model;
receiving, by the first computer system, a matrix solving request includes the untrained matrix solving approach application model;
solving, by the first computer system, the received request with trained matrix solving approach library;
retraining and purifying, by the first computer system, request matrix solving request incrementally under supervising with the latest hardware during real matrix solving approach;
updating, by the first computer system, the purified matrix solving approach model continuing to solve the requested matric until to searched acceptable results;
returning, by the first computer system, solved matrix with results;

2. The computer implement method of claim 1, wherein the trained matrix solving approach library package is trained and built from a matrix solving machine learning and training method. The method comprising:
receiving, a second computer system, a request to train and generate a matrix solving Machine Learning (ML) model associated the type of requested problems and domain;
constructing and designing, by the second computer system, a model structure of the Machine Learning (ML) Model for the received type of requested problems and domain;
selecting, by the second computer system, a set of matrices solving sampling data for training the defined matrix solving Machine Learning (ML) model;
using, by the second computer system, the selected matrix solving data and constructed IMSA Structure as inputs to train the matrix solving Machine Learning (ML) model;
generating, by the second computer system, a new matrix solving Machine leaning model with optimized IMSA parameters as Machine leaning model output: Matrix partitioning; Pivoting; Preconditioner; convergence tolerance; degeneracy avoidance;
training/optimizing, by the second computer system, the weights for each Machine leaning model node according to the provided training data sets for the specific IMSA Application domain;
verifying, by the second computer system, generated and trained matrix solving approach library package with untrained data sets (matrix solving problems).

3. The computer implement method of claim 1, wherein generating matrix solving approach library package includes:
training and building a matrix solving approach library package in the second computer system;
installing and build the matrix solving approach library package in the first computing system for support a matrix solving approach application.

4. A computer program product for optimizing a matrix solving approach enhanced with integrated real time machine learning training and inference, the method comprising:
installing a trained matrix solving approach library package with an untrained or pre-trained for targeting matrix solving approach application model;
receiving a matrix solving request includes the untrained matrix solving approach application model;
solving the received request with trained matrix solving approach library;
retraining and purifying request matrix solving request incrementally under supervising with the latest hardware during real matrix solving approach;
updating the purified matrix solving approach model continuing to solve the requested matric until to searched acceptable results;
returning solved matrix with results;

5. The computer program product of claim 4, wherein the trained matrix solving approach library package is trained and built from a matrix solving machine learning and training method. The method comprising:
receiving a request to train and generate a matrix solving Machine Learning (ML) model associated the type of requested problems and domain;
constructing and designing a model structure of the Machine Learning (ML) Model for the received type of requested problems and domain;
selecting a set of matrices solving sampling data for training the defined matrix solving Machine Learning (ML) model;
using the selected matrix solving data and constructed IMSA Structure as inputs to train the matrix solving Machine Learning (ML) model;
generating a new matrix solving Machine leaning model with optimized matric solving module parameters as Machine leaning model outputs: Matrix partitioning; Pivoting; Preconditioner; convergence tolerance; degeneracy avoidance;
training/optimizing the weights for each Machine leaning model node according to the provided training data sets for the specific IMSA Application domain;
verifying generated and trained matrix solving approach library package with untrained data sets (matrix solving problems).

6. The computer program product of claim 4, wherein generating matrix solving approach library package includes:
training and building a matrix solving approach library package;
installing and build the matrix solving approach library package for support a matrix solving approach application.
